(19) United States
(12) Patent Application Publication
(10) Pub. No.: US 2023/0392351 A1
(43) Pub. Date: Dec. 7, 2023

(54) SAFETY EVALUATION SYSTEM AND SAFETY EVALUATION METHOD

(71) Applicant: Komatsu Ltd., Tokyo (JP)

(72) Inventors: Takahiro Matsui, Tokyo (JP); Takuya Hino, Tokyo (JP); Hidehiko Kobayashi, Tokyo (JP)

(73) Assignee: Komatsu Ltd., Tokyo (JP)

(21) Appl. No.: 18/032,835

(22) PCT Filed: Oct. 18, 2021
(86) PCT No.: PCT/JP2021/038419

§ 371 Date: Apr. 20, 2023

(30) Foreign Application Priority Data
Oct. 27, 2020 (JP) 2020-179855

(51) Int. Cl. E02F 9/26; E02F 9/24

(52) U.S. Cl. CPC E02F 9/261; E02F 9/24

(57) ABSTRACT

A risk detection unit detects an occurrence risk of an incident related to a work machine. A time calculation unit measures a risk time from an occurrence time of the risk to an elimination time of the risk. An evaluation unit calculates a safety evaluation index on the basis of the risk time. An output unit outputs the safety evaluation index.

### TECHNICAL FIELD

The present disclosure relates to a safety evaluation system and a safety evaluation method for a work machine.

Priority is claimed on Japanese Patent Application No. 2020-179855, filed Oct. 27, 2020, the content of which is incorporated herein by reference.

### BACKGROUND ART

Patent Document 1 discloses a technique for outputting approach information indicating that an obstacle has been detected around a work machine. The approach information according to Patent Document 1 represents the number of times of obstacle detection.

### CITATION LIST

### Patent Document

### [Patent Document 1]

Japanese Unexamined Patent Application, First Publication No. 2018-141314

### SUMMARY OF INVENTION

### Technical Problem

Meanwhile, the number of times the occurrence risk of an incident related to a work machine, such as the detection of an obstacle, is detected can certainly represent the magnitude of the risk. On the other hand, in a case where the risk is eliminated immediately after the occurrence of the risk and in a case where a state having the risk continues, the actual magnitudes of the risk are considered to be different from each other even if the numbers of times of detection are the same. That is, there is a possibility that the safety cannot be appropriately evaluated only by the number of times of detection of the risk.

An object of the present disclosure is to provide a safety evaluation system and a safety evaluation method capable of appropriately evaluating the safety of work machines.

### Solution to Problem

According to one aspect of the present invention, the safety evaluation system includes a risk detection unit that detects an occurrence risk of an incident related to a work machine; a time calculation unit that measures a risk time from an occurrence time of the risk to an elimination time of the risk; an evaluation unit that calculates a safety evaluation index on the basis of the risk time; and an output unit that outputs the safety evaluation index.

### Advantageous Effects of Invention

According to the aspect described above, the safety evaluation system can appropriately evaluate the safety of the work machine.

### BRIEF DESCRIPTION OF DRAWINGS

FIG. 1 is a schematic diagram showing the configuration of a risk management system according to a first embodiment.

FIG. 2 is a diagram showing the configuration of a work machine according to the first embodiment.

FIG. 3 is a schematic block diagram showing the configuration of a control device according to the first embodiment.

FIG. 4 is a schematic block diagram showing the configuration of a report generation device according to the first embodiment.

FIG. 5 is a flowchart showing a method of calculating a fall-risk-related score according to the first embodiment.

FIG. 6 is a diagram showing variables related to the calculation of an energy stability margin.

FIG. 7 is a flowchart showing a method of calculating a collision-risk-related score according to the first embodiment.

FIG. 8 is a diagram showing determination criteria for determining a collision-related incident risk caused by a work machine according to the first embodiment.

FIG. 9 is a diagram showing an example of an incident report according to the first embodiment.

FIG. 10 is a flowchart showing the operation of the report generation device according to the first embodiment.

### DESCRIPTION OF EMBODIMENTS

### First Embodiment

<<Configuration of Risk Management System 1>>

Hereinafter, embodiments will be described in detail with reference to the drawings.

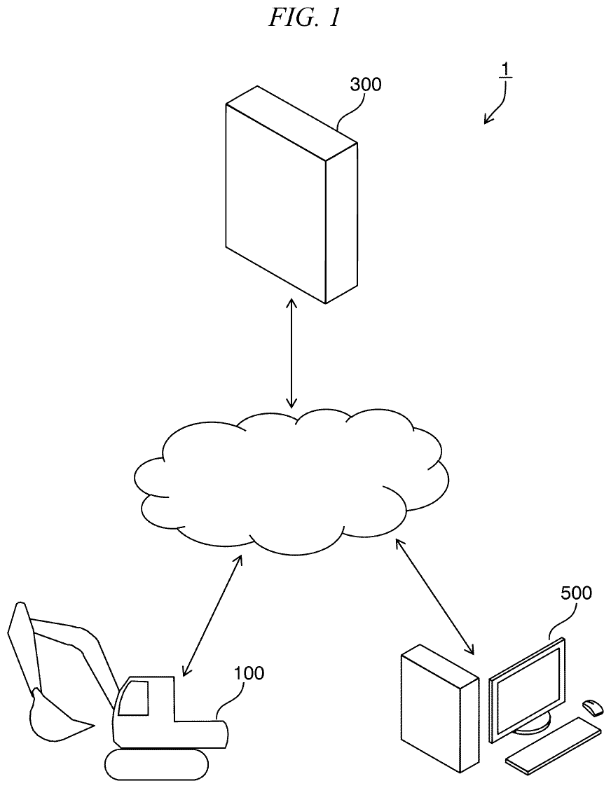

FIG. 1 is a schematic diagram showing the configuration of a risk management system 1 according to a first embodiment. The risk management system 1 presents an incident report related to the occurrence risk of an incident related to the work machine 100 to a user. As the user, an operation site manager or an operator of the work machine 100 is an exemplary example. By visually recognizing the incident report, the user can examine the maintenance of an operation site, and can guide the operation by the operator.

The risk management system 1 includes the work machine 100, a report generation device 300, and a user terminal 500. The work machine 100, the report generation device 300, and the user terminal 500 are communicably connected to each other via a network.

In a case where the work machine 100 is, for example, a hydraulic excavator, the work machine operates at a construction site to perform earth excavation work. Additionally, in a case where it is determined that there is a predetermined incident risk on the basis of the work state, the work machine 100 issues a warning to notify the operator of the incident risk. The details of the determination of the incident risk will be described below. As the incident risk, collision risk, fall risk, and non-compliance risk are exemplary examples. The work machine 100 shown in FIG. 1 is a hydraulic excavator, but may be other work machines in other embodiments. As the work machine 100, bulldozers, dump trucks, forklifts, wheel loaders, motor graders, and the like are exemplary examples.

The report generation device 300 generates incident report data in which the occurrence risk of an incident related to the work machine 100 is summarized.

The user terminal 500 displays or prints the incident report data generated by the report generation device 300.

<<Configuration of Work Machine 100>>

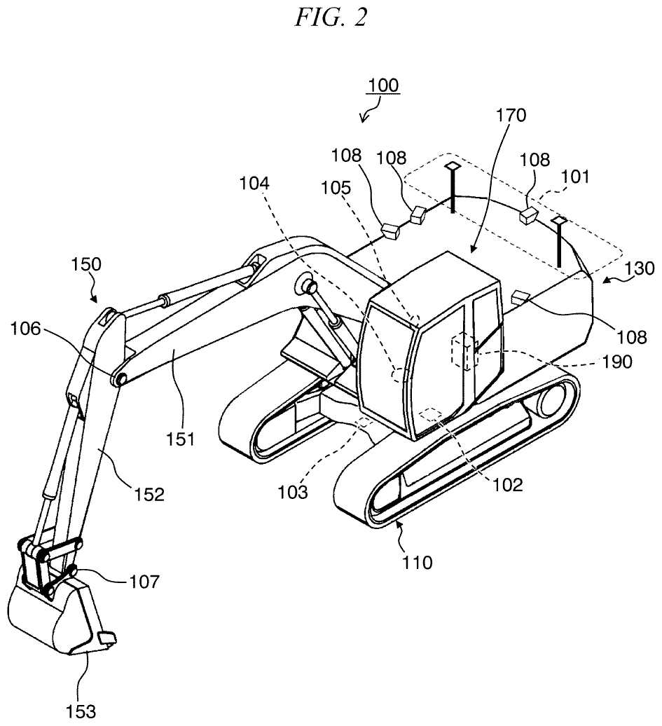

FIG. 2 is a diagram showing the configuration of the work machine 100 according to the first embodiment.

The work machine 100 includes an undercarriage 110, a swing body 130, work equipment 150, a cab 170, and a control device 190.

The undercarriage 110 supports the work machine 100 in a travelable manner. The undercarriage 110 is, for example, a pair of left and right endless tracks.

The swing body 130 is supported by the undercarriage 110 so as to be swingable about a swing center.

The work equipment 150 is supported on a front portion of the swing body 130 so as to be drivable in an up-down direction. The work equipment 150 is hydraulically driven. The work equipment 150 includes a boom 151, an arm 152, and a bucket 153. A proximal end portion of the boom 151 is attached to the swing body 130 via a pin. A proximal end portion of the arm 152 is attached to a tip portion of the boom 151 via a pin. A proximal end portion of the bucket 153 is attached to a tip portion of the arm 152 via a pin. Here, a portion of the swing body 130 to which the work equipment 150 is attached is referred to as the front portion. Additionally, a portion of the swing body 130 opposite to the front portion is referred to as a rear portion, a portion of the swing body 130 on the left side of the front portion is referred to as a left portion, and a portion of the swing body 130 on the right side of the front portion is referred to as a right portion.

The cab 170 is provided at the front portion of the swing body 130. A manipulation device for manipulating the work machine 100 and a warning device for issuing an incident risk warning are provided in the cab 170.

The control device 190 controls the undercarriage 110, the swing body 130, and the work equipment 150 on the basis of an operator's manipulation. The control device 190 is provided, for example, inside the cab. The control device 190 is an example of an operation area presentation device.

The work machine 100 includes a plurality of sensors for detecting the work state of the work machine 100. Specifically, the work machine 100 includes a position and azimuth direction detector 101, an inclination detector 102, a traveling acceleration sensor 103, a swing angle sensor 104, a boom angle sensor 105, an arm angle sensor 106, a bucket angle sensor 107, a plurality of imaging devices 108, and a plurality of radar devices 109.

Work Machine 100

The position and azimuth direction detector 101 calculates the position of the swing body 130 in the field coordinate system and the azimuth direction to which the swing body 130 faces. The position and azimuth direction detector 101 includes two antennas that receive positioning signals from artificial satellites that constitute the GNSS. Each of the two antennas is installed at a different position on the swing body 130. For example, the two antennas are provided on a counterweight portion of the swing body 130. The position and azimuth direction detector 101 detects the position of a representative point of the swing body 130 in the field coordinate system on the basis of a positioning signal received by at least one of the two antennas. The position and azimuth direction detector 101 detects the azimuth direction to which the swing body 130 faces in the field coordinate system, using the positioning signal received by each of the two antennas.

The inclination detector 102 measures the acceleration and angular velocity of the swing body 130 and detects the inclination (for example, roll angle and pitch angle) of the swing body 130 with respect to the horizontal plane on the basis of the measurement result. The inclination detector 102 is installed, for example, below the cab 170. As the inclination detector 102, an inertial measurement unit (IMU) is an exemplary example.

The traveling acceleration sensor 103 is provided on the undercarriage 110 and detects acceleration related to the traveling of the work machine 100.

The swing angle sensor 104 is provided at the swing center of the swing body 130 and detects the swing angles of the undercarriage 110 and the swing body 130.

The boom angle sensor 105 is provided on a pin that connects the swing body 130 and the boom 151 to each other and detects a boom angle, which is the rotation angle of the boom 151 with respect to the swing body 130.

The arm angle sensor 106 is provided on a pin that connects the boom 151 and the arm 152 to each other and detects an arm angle, which is the rotation angle of the arm 152 with respect to the boom 151.

The bucket angle sensor 107 is provided on a pin that connects the arm 152 and the bucket 153 to each other and detects a bucket angle, which is the rotation angle of the bucket 153 with respect to the arm 152.

Each of the plurality of imaging devices 108 is provided on the swing body 130. The imaging ranges of the plurality of imaging devices 108 cover at least a range, which cannot be visually recognized from the cab 170, in the entire circumference of the work machine 100.

Each of the plurality of radar devices 109 is provided on the swing body 130. The imaging ranges of the plurality of radar devices 109 cover at least a range, which cannot be visually recognized from the cab 170, in the entire circumference of the work machine 100.

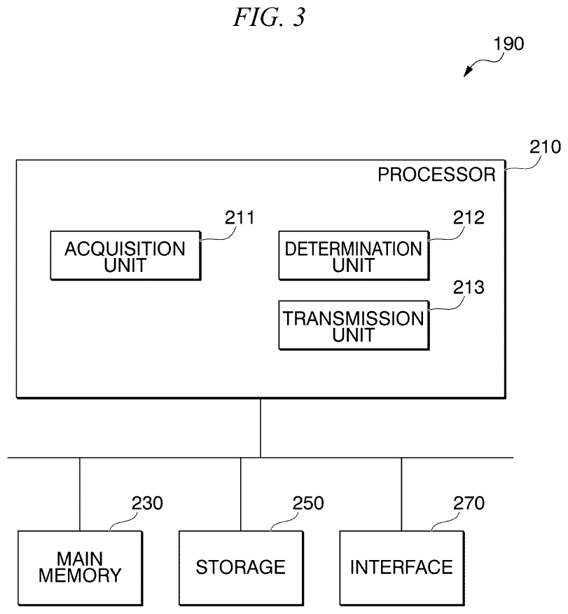

FIG. 3 is a schematic block diagram showing the configuration of the control device 190 according to the first embodiment.

The control device 190 is a computer that includes a processor 210, a main memory 230, a storage 250, and an interface 270.

The storage 250 is a non-transitory, tangible storage medium. As the storage 250, magnetic disks, optical disks, magneto-optical disks, semiconductor memories, and the like are exemplary examples. The storage 250 may be internal media directly connected to a bus of the control device 190, or may be external media connected to the control device 190 via the interface 270 or a communication line. The storage 250 stores programs for controlling the work machine 100.

The programs may be for realizing part of the functions that the control device 190 is caused to exhibit. For example, the programs may exhibit functions in combination with other programs already stored in the storage 250 or in combination with other programs mounted on other devices. In addition, in other embodiments, the control device 190 may include a customed large scale integrated circuit (LSI) such as a programmable logic device (PLD) in addition to or instead of the above configuration. As the PLDs, a programmable array logic (PAL), a generic array logic (GAL), a complex programmable logic device (CPLD), and a field programmable gate array (FPGA) are exemplary examples. In this case, part or all of the functions realized by the processor may be realized by the integrated circuit.

The processor 210 functions as an acquisition unit 211, a determination unit 212, and a transmission unit 213 by executing the programs.

The acquisition unit 211 acquires a measured value from each of the position and azimuth direction detector 101, the inclination detector 102, the traveling acceleration sensor 103, the swing angle sensor 104, the boom angle sensor 105, the arm angle sensor 106, the bucket angle sensor 107, the imaging devices 108, and the radar devices 109. In addition, the measured values of the imaging devices 108 are captured images.

In addition, among the information acquired by the acquisition unit 211, at least the position information acquired by the position and azimuth direction detector 101 is always stored at predetermined time intervals during the operation of the work machine 100, and accumulated as position history data during operation.

The determination unit 212 determines the presence or absence of an incident risk on the basis of the measured value acquired by the acquisition unit 211, and outputs a warning output instruction to the warning device in a case where it is determined that there is an incident risk. When the warning output instruction is input, the warning device issues a warning to notify the operator of the presence of the incident risk.

As the incident risk, fall risk, collision risk, and non-compliance risk are exemplary examples. As the fall risk, unstable postures on slopes and unstable postures during lifting work are exemplary examples. As the collision risk, the entering of an obstacle or person into a dangerous region, and the mismatch (hereinafter referred to as “reversal of the orientation of the undercarriage 110”) between the orientation of the undercarriage 110 and the orientation of the swing body 130 (that is, the orientation of the cab 170) during traveling are exemplary examples. As the non-compliance risk, ignoring a warning and reversing the orientation of the undercarriage 110 when leaving the seat are exemplary examples. In addition, not wearing a seatbelt and driving under the influence of alcohol can also be included in the non-compliance risk.

The determination unit 212 can determine the presence or absence of a fall risk by calculating the posture of the work machine 100 on the basis of the inclination of the work machine 100 with respect to the horizontal plane detected by the inclination detector 102. Additionally, the determination unit 212 may determine the presence or absence of a fall risk by calculating the center of gravity of the work machine 100. Additionally, the posture of the work machine 100 may be calculated further using the swing angle of the swing body 130, the angle of the work equipment 150, and the like in addition to the inclination of the work machine 100 with respect to the horizontal plane.

The determination unit 212 can determine the presence or absence of a collision risk by pattern matching of a portion corresponding to the dangerous region in an image captured by each imaging device 108. Additionally, the determination unit 212 can determine the presence or absence of a collision risk by determining the presence or absence of an obstacle in the dangerous region depending on the distance data acquired by the radar devices 109.

The transmission unit 213 transmits data (hereinafter referred to as “warning history data”) indicating the history of the state of the work machine 100 when a warning was issued and the above-described position history data during operation to the report generation device 300. The warning history data includes information on the time when the warning output instruction was output, the measured value at that time, and the position of work machine 100 at that time. The transmission unit 213 generates the warning history data by associating the time, the measured value, and the positional information from when the determination unit 212 determines that there is an incident risk to when the determination unit 212 determines that there is no incident risk. The transmission unit 213 may transmit history data such as the warning history data and the position history data during operation to the report generation device 300 by batch processing at a predetermined transmission timing, or may transmit the history data to the report generation device 300 in real time. In a case where the history data is transmitted by the batch processing, the acquisition unit 211 records the history data in the storage 250, and the transmission unit 213 transmits the recorded history data to the report generation device 300. In addition, in order to reduce the amount of communication, the transmission unit 213 may compress and transmit the history data as necessary. The history data transmitted by the transmission unit 213 includes the identification information of the operator who manipulates the work machine 100. The identification information of the operator is read from an ID key, for example, when the work machine 100 is started.

<<Configuration of Report Generation Device 300>>

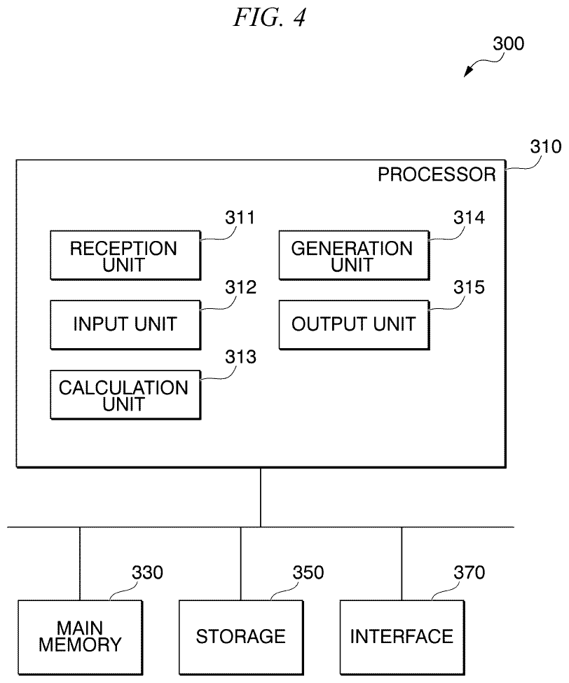

FIG. 4 is a schematic block diagram showing the configuration of the report generation device 300 according to the first embodiment.

The report generation device 300 is a computer comprising a processor 310, a main memory 330, a storage 350, and an interface 370.

The storage 350 is a non-transitory tangible storage medium. As the storage 350, magnetic disks, magneto-optical disks, optical disks, semiconductor memories, and the like are exemplary examples. The storage 350 may be internal media directly connected to the bus of the report generation device 300, or may be external media connected to the report generation device 300 via the interface 370 or communication line. The storage 350 stores a program for generating incident reports.

The program may be for realizing part of the functions that the report generation device 300 is caused to exhibit. For example, the programs may exhibit functions in combination with other programs already stored in the storage 350 or in combination with other programs mounted on other devices. In addition, in other embodiments, the report generation device 300 may include a customed LSI in addition to or instead of the above configuration. In this case, part or all of the functions realized by the processor may be realized by the integrated circuit.

In the storage 350, map data of the operation site is recorded in advance.

The processor 310 functions as a reception unit 311, an input unit 312, a calculation unit 313, a generation unit 314, and an output unit 315 by executing the programs.

The reception unit 311 receives the history data including the warning history data and the position history data during operation from the work machine 100. The reception unit 311 records the received history data in the storage 350.

The input unit 312 receives an input of an evaluation target the incident report from the user terminal 500. The evaluation target is specified depending on a period related to the evaluation and the identification information of the operator or the identification information of the operation site.

On the basis of the warning history data received by the reception unit 311, the calculation unit 313 calculates a score indicating the magnitude of each of a plurality of incident risks related to the input evaluation period and evaluation target. Additionally, the calculation unit 313 calculates a value used for generating the incident report on the basis of the warning history data received by the reception unit 311 and the calculated score.

Additionally, the calculation unit 313 also calculates the stay time of the work machine 100 in each area of the operation site, which will be described below, on the basis of the position history data during the operation of the reception unit 311.

The generation unit 314 generates the incident report data representing the incident report on the basis of the result calculated by the calculation unit 313.

The output unit 315 outputs the incident report data generated by the generation unit 314 to the user terminal 500.

<<Score Calculation Method>>

Here, an example of a method of calculating an incident-risk-related score by the calculation unit 313 will be described.

(Fall-Risk-Related Score)

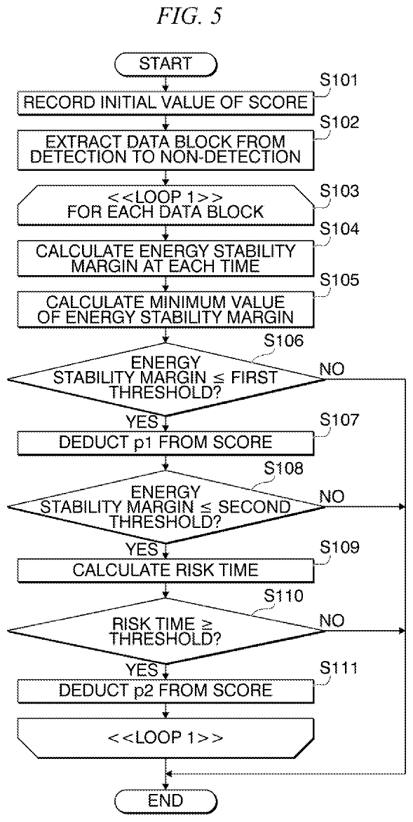

First, a method for calculating a fall-risk-related score will be described. FIG. 5 is a flowchart showing a method of calculating a fall-risk-related score according to the first embodiment. The calculation unit 313 records an initial value of the fall-risk-related score representing a full score in the main memory 330 (Step S101). The calculation unit 313 extracts a plurality of data blocks representing a period from when the incident risk was detected to when the incident risk was no longer detected from the warning history data (Step S102). For example, the calculation unit 313 can extract the plurality of data blocks by dividing the warning history data at positions where the times are discontinuous. The calculation unit 313 selects the plurality of data blocks one by one (Step S103), and performs the processing of the following Steps S104 to S111 on the selected data blocks.

The calculation unit 313 calculates the energy stability margin of the work machine 100 at each time on the basis of the measured values of the inclination detector 102, the boom angle sensor 105, the arm angle sensor 106, and the bucket angle sensor 107 included in the selected data block, and the known shape, weight, and center-of-gravity position of each part of the work machine 100 (Step S104). The energy stability margin is an amount representing the magnitude of energy that must be supplied until the work machine 100 falls, and is obtained by the following Formula (1).

$$[ Formula 1 ]$$

$$E = Mg \cdot H [ 1 - cos ( {tan}^{- 1} ( \frac{x}{z} ) - θ ) ] \qquad ( 1 )$$

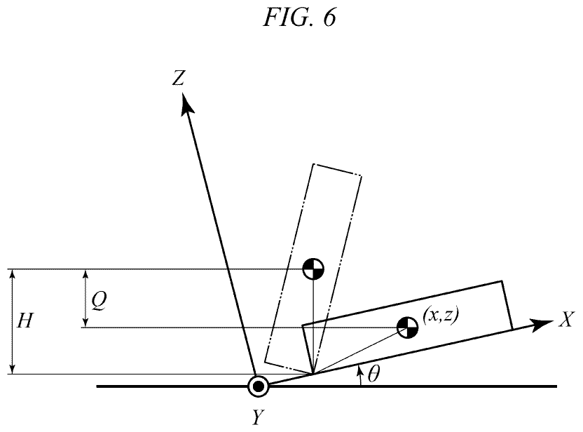

FIG. 6 is a diagram showing variables related to the calculation of the energy stability margin. In Formula (1), E indicates the energy stability margin. M indicates the total weight of the work machine 100. g indicates gravitational acceleration. H represents the height from the grounding point of the work machine 100 to the static center-of-gravity position of the work machine 100 in a fallen posture. x and z indicate the values of an X coordinate and a Z coordinate in a vehicle body coordinate system of the current static center-of-gravity position of the work machine 100. θ indicates the inclination of work machine 100 with respect to the horizontal plane.

The calculation unit 313 specifies a minimum value of the energy stability margin in the selected data block (Step S105). The calculation unit 313 determines whether or not the minimum value of the energy stability margin is equal to or less than a first threshold (Step S106). The first threshold is a threshold indicating that there is a possibility that a fall will occur. In a case where the minimum value of the energy stability margin is equal to or less than the first threshold (Step S106: YES), the calculation unit 313 subtracts a first deduction point p1 from the fall-risk-related score stored in the main memory 330 (Step S107). In addition, in a case where the energy stability margin is greater than the first threshold (Step S106: NO), the score is not subtracted. That is, the calculation unit 313 subtracts the first deduction point p1 from the score by the number of data blocks in which the minimum value of the energy stability margin is equal to or less than the first threshold, that is, the number of times the energy stability margin is equal to or less than the first threshold. Accordingly, the score is subtracted by the product of the number of times the energy stability margin is equal to or less than the first threshold and the first deduction point p1. The number of times the energy stability margin is equal to or less than the first threshold can be said to be the number of times of occurrence of the incident risk.

Next, the calculation unit 313 determines whether or not the minimum value of the energy stability margin is equal to or less than a second threshold (Step S108). The second threshold is a threshold indicating that the possibility of falling is high. The second threshold is less than the first threshold. In a case where the minimum value of the energy stability margin is equal to or less than the second threshold (Step S108: YES), the calculation unit 313 calculates the risk time from the incident risk occurrence time to the elimination time thereof in the selected data block (Step S109). The risk time is obtained by finding the difference between the first time and the last time of the data block. In a case where the work machine 100 returns after having fallen, it can be said that the fall-risk-related risk time is the time from the fall to the return. Additionally, in a case where the work machine 100 is stopped without returning after having fallen, it can be said that the fall-risk-related risk time is the time from the fall until the control device 190 stops. The calculation unit 313 determines whether or not the risk time is equal to or greater than a predetermined threshold (Step S110).

In a case where the risk time is equal to or greater than the predetermined threshold (Step S110: YES), there is a high possibility that work machine 100 has fallen. Accordingly, the calculation unit 313 subtracts a second deduction point p2 from the fall-risk-related score stored in the main memory 330 (Step S111). The second deduction point p2 is a value sufficiently greater than the first deduction point p1. In addition, in a case where the energy stability margin is greater than the second threshold (Step S108: NO) or in a case where the risk time is less than the threshold (Step S110: NO), the second deduction point p2 is not subtracted from the score. That is, the calculation unit 313 subtracts the second deduction point p2 from the score by the number of data blocks in which the risk time is equal to or greater than the threshold, that is, the number of times the risk time is equal to or greater than the threshold. Accordingly, the score is subtracted by the product of the number of times the risk time is the threshold or greater and the second deduction point p2.

The calculation unit 313 calculates the fall-risk-related score by performing the above calculation for each data block. That is, the calculation unit 313 calculates the fall-risk-related score by subtracting the sum of a value obtained by multiplying the number of times the risk time exceeds the predetermined threshold by the second deduction point and a value obtained by multiplying the number of times of occurrence of the incident risk by the first deduction point from the full score. In addition, in other embodiments, the score may be calculated using the zero moment point of the work machine 100 instead of the energy stability margin.

(Collision-Risk-Related Score)

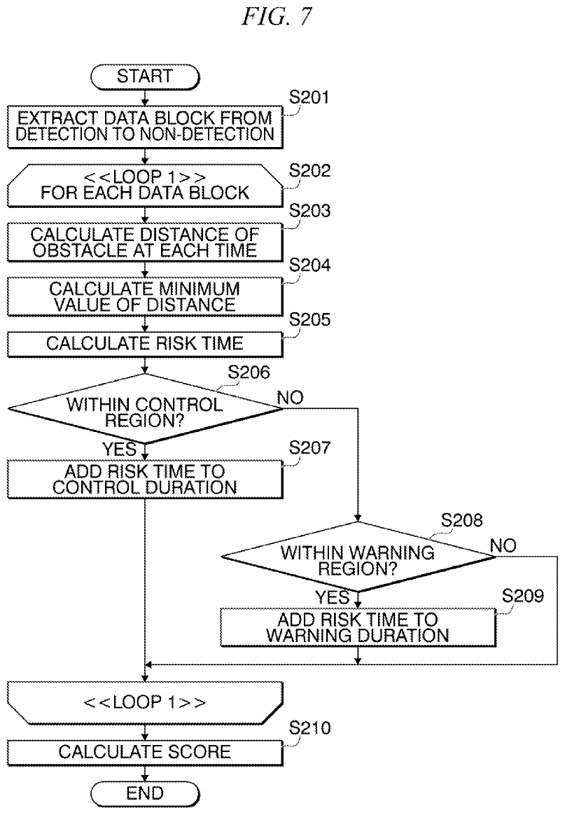

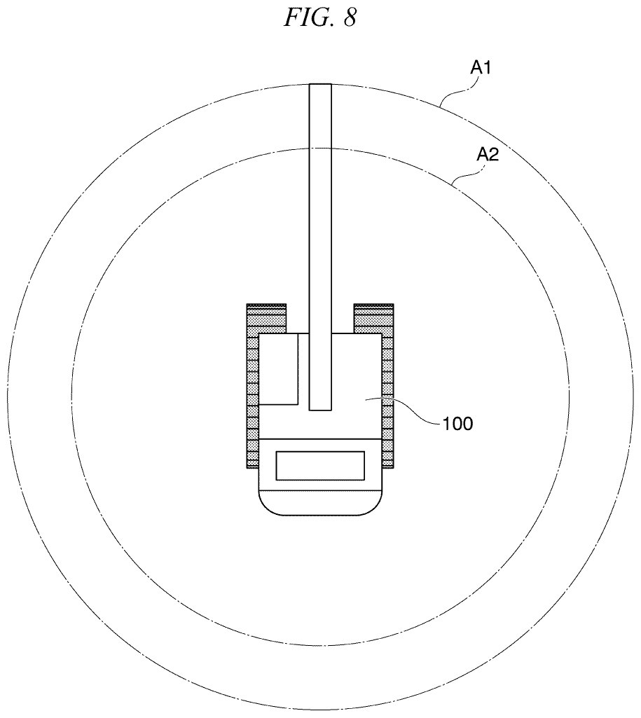

A method of calculating a collision-risk-related score will be described. FIG. 7 is a flowchart showing a method of calculating the collision-risk-related score according to the first embodiment. The calculation unit 313 extracts a plurality of data blocks representing a period from when the incident risk is detected to when the incident risk is no longer detected from the warning history data (Step S201). That is, the calculation unit 313 extracts a data block indicating the state of the work machine 100 from when entering of at least one obstacle into a warning region is detected to which all obstacles are no longer detected within the warning region. FIG. 8 is a diagram showing determination criteria for determining a collision-related incident risk caused by the work machine 100 according to the first embodiment. As shown in FIG. 8, the control device 190 of the work machine 100 detects the collision-related incident risk by determining whether or not an obstacle is present inside a warning region A1 and a control region A2 centered on the swing center of the work machine 100. The warning region A1 is a region for generating a warning to notify the presence of an obstacle. The warning region A1 shown in FIG. 8 is a circular region centered on the swing center and having a radius close to the length of the boom 151. The control region A2 is a region in which intervention control is generated to forcibly stop the work machine 100 so that the work machine 100 does not come into contact with the obstacle. The control region A2 shown in FIG. 8 is a circular region centered on the swing center and having a radius shorter than that of the warning region A1.

The calculation unit 313 selects a plurality of data blocks one by one (Step S202), and performs the processing of the following Steps S203 to S209 on the selected data blocks.

The calculation unit 313 calculates the distance from the work machine 100 to the obstacle at each time on the basis of the captured images of the imaging devices 108 and the measured values of the radar devices 109 (Step S203). In this case, in a case where a plurality of obstacles are detected from the captured images and the measured values of the radar device 109, the calculation unit 313 calculates the distance of an obstacle closest to the work machine 100. Next, the calculation unit 313 specifies a minimum value of the distance in the selected data block (Step S204). The calculation unit 313 calculates a risk time related to the selected data block (Step S205). The risk time related to the collision risk is the time from when the presence of the obstacle within the warning region is detected to when the presence of the obstacle within the warning region is no longer detected.

On the basis of the minimum value of the distance, the calculation unit 313 determines whether or not the obstacle has been present within the control region centered on the work machine 100 during a period related to the selected data block (Step S206). In a case where the calculation unit 313 determines that the obstacle is present within the control region (Step S206: YES), the calculation unit 313 adds the risk time calculated in Step S205 to a control duration stored in the main memory 330, thereby updating the control duration (Step S207).

In a case where the calculation unit 313 determines that the obstacle is not present within the control region (Step S206: NO), the calculation unit 313 determines whether or not the obstacle is present within the warning region centered on the work machine 100 (Step S208). In a case where the calculation unit 313 determines that the obstacle is present within the control region (Step S208: YES), the calculation unit 313 adds the risk time calculated in Step S205 to a warning duration stored in the main memory 330, thereby updating the warning duration (Step S209). In a case where the calculation unit 313 determines that the obstacle is not present in the control region or the warning region (Step S208: NO), the calculation unit 313 does not perform the addition of the risk time.

When the processing of Steps S203 to S209 for each selected data block is performed, the calculation unit 313 calculates a collision-risk-related score on the basis of the calculated control duration and warning duration (Step S210). Specifically, the calculation unit 313 calculates the collision-risk-related score on the basis of the following Formula (2).

$$[ Formula 2 ]$$

$$score = 100 - \frac{A \{ t 1 + B \cdot t 2 \}}{T} \qquad ( 2 )$$

In Formula (2), the score indicates the collision-risk-related score. t1 indicates the warning duration. t2 indicates the control duration. A indicates a coefficient indicating the intensity of the degree of deduction for the risk time. B indicates the weight for the presence of an obstacle in the control region. T indicates the operation time of the work machine 100. The operation time may be specified by the time on the service meter of the work machine 100.

(Other Scores)

For example, the calculation unit 313 calculates a score related to the reversal of the orientation of the undercarriage 110 such that the closer the measured value of the swing angle sensor 104 is to ±0 degrees, the larger the value, and the closer the measured value is to 180 degrees, the smaller the value.

For example, the calculation unit 313 calculates a score related to ignoring the warning such that the longer the elapsed time from the time when the warning device issues the warning to the time when the warning is canceled, the smaller the value.

### Examples of Incident Report

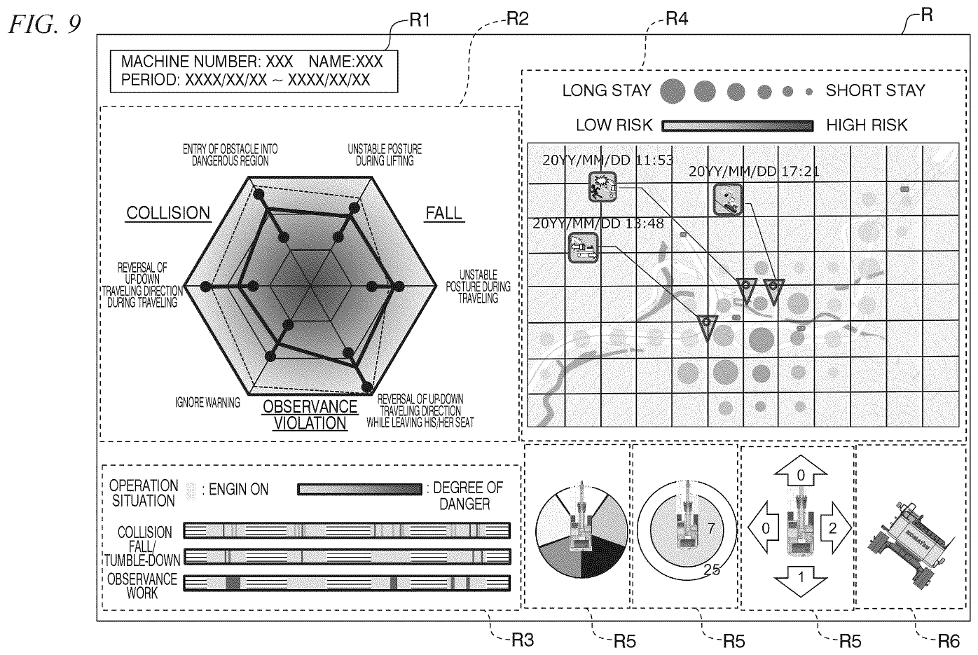

FIG. 9 is a diagram showing an example of the incident report R according to the first embodiment.

The incident report R includes evaluation target information R1, a radar chart R2, a time chart R3, an operation area map R4, an inclination frequency image R5, an inclination posture image R6, a direction-specific obstacle frequency image R7, and a distance-specific obstacle frequency image R8.

The evaluation target information R1 is information representing an evaluation target related to the incident report R. The evaluation target information R1 includes the machine number of the work machine 100, the name of the operator, and the evaluation period.

The radar chart R2 represents a score related to each of a plurality of incident risks. The radar chart R2 represents the average score, maximum score, and minimum score of an operator related to the evaluation target, and the average score of a plurality of operators.

The time chart R3 represents changes over time in scores of the plurality of incident risks during the evaluation period.

The operation area map R4 represents the stay time of the work machine 100 in each area of the operation site, the magnitude of the risk in each area, and a position where each incident-risk-related score is minimum, that is, a position where the risk is maximum. In the example shown in HG. 9, the operation area map R4 includes a map representing the operation site, a grid that divides the operation site into a plurality of areas, an object that indicates the stay time in each area and the magnitude of the risk, and a pin indicating a position where the incident risk is maximum. That is, the report generation device 300 is an example of the operation area presentation device.

The inclination frequency image R5 represents the number of times a fall-risk-related warning was issued for each inclination direction of the work machine 100. Specifically, the inclination frequency image R5 includes a machine image, a front detection image, a rear detection image, a left detection image, and a right detection image. The machine image represents the work machine 100. The front detection image is disposed in front of the machine image (upper side in the drawing) and represents the number of times the fall risk is issued during forward inclination. The rear detection image is disposed behind the machine image (lower side in the drawing) and represents the number of times the fall risk is issued during backward inclination. The left detection image is disposed on the left side of the machine image (left side in the drawing) and represents the number of times the fall risk is issued during leftward inclination. The right detection image is disposed on the right side of the machine image (right side in the drawing) and represents the number of times the fall risk is issued during rightward inclination.

The inclination posture image R6 represents the posture of the work machine 100 when the fall-risk-related score is maximum. That is, the inclination posture image R6 represents the posture of the work machine 100 when the inclination angle of the work machine 100 with respect to the horizontal plane is the largest during the period indicated by R1.

The direction-specific obstacle frequency image R7 represents the direction-specific frequency of warnings related to the entering risk of an obstacle in the vicinity of the work machine 100. Specifically, the direction-specific obstacle frequency image R7 includes a machine image, a front detection image, a front right detection image, a rear right detection image, a rear left detection image, and a front left detection image. The machine image represents the work machine 100. The front detection image is disposed in front of the machine image (upper side in the drawing) and represents the frequency at which obstacles are detected in front of the work machine 100 in the warning region. The front right detection image is disposed at the front right (upper right side in the drawing) of the machine image, and represents the frequency at which obstacles are detected at the front right of the work machine 100 in the warning region. The rear right detection image is disposed at the rear right (lower right side in the drawing) of the machine image, and represents the frequency at which obstacles are detected at the rear right of the work machine 100 in the warning region. The rear left detection image is disposed at the rear left (lower left side in the drawing) of the machine image, and represents the frequency at which obstacles are detected at the rear left of the work machine 100 in the warning region. The front left detection image is disposed at the front left (upper left side in the drawing) of the machine image, and represents the frequency at which obstacles are detected at the front left of the work machine 100 in the warning region. Each detection image represents the frequency at which obstacles are detected depending on hue. For example, the lower the detection frequency, the closer the hue is to blue, and the higher the detection frequency, the closer the hue is to red. The detection frequency is obtained, for example, by normalizing the number of times of detection.

The distance-specific obstacle frequency image R8 represents the region-specific frequency of warnings related to the entering risk of an obstacle in the vicinity of work machine 100. Specifically, the distance-specific obstacle frequency image R8 includes a machine image, a warning region detection image, and a control region detection image. The machine image represents the work machine 100. The warning region detection image is a yellow donut-shaped image disposed at a position corresponding to the warning region surrounding the machine image, and represents the frequency at which obstacles are detected in the warning region. The control region detection image is a red circular image disposed at a position corresponding to the control region surrounding the machine image, and represents the frequency at which obstacles are detected in the control region. Each detection image represents the number of times obstacles are detected by a numerical value.

<<Operation of Control Device 190<<

The acquisition unit 211 of the control device 190 of the work machine 100 acquires measured values from various sensors according to a predetermined sampling cycle during the operation of the work machine 100. The determination unit 212 determines the presence or absence of an incident risk on the basis of the measured value, and outputs a warning output instruction to the warning device in a case where it is determined that there is an incident risk. The transmission unit 213 transmits the history data such as the warning history data and the position history data during operation to the report generation device 300. The warning history data is generated when the determination unit 212 outputs the warning output instruction. Additionally, the position history data during operation is generated at predetermined time intervals during the operation of the work machine 100. The reception unit 311 of the report generation device 300 receives the history data from the work machine 100 and records the received history data in the storage 350. Accordingly, the history data of the plurality of work machines 100 is collected in the storage 350 of the report generation device 300.

<<Operation of Report Generation Device 300>>

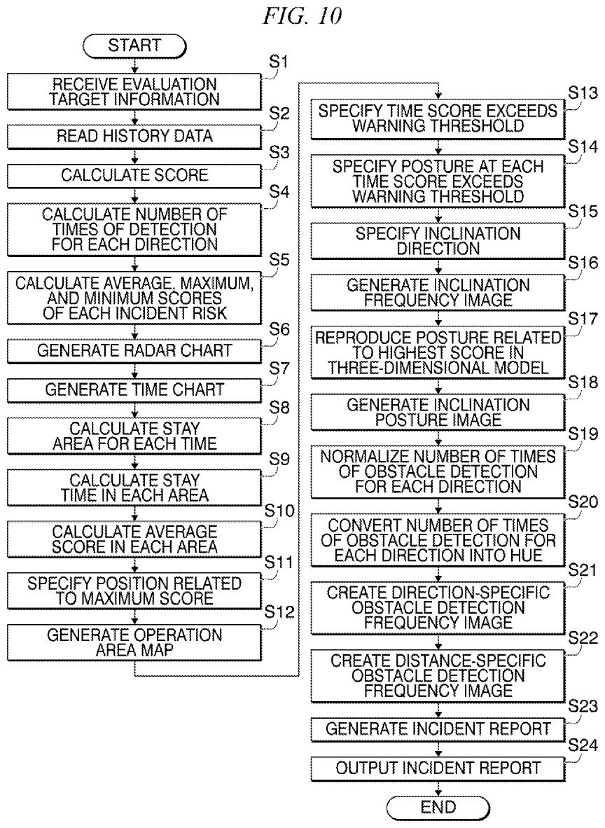

FIG. 10 is a flowchart showing the operation of the report generation device 300 according to the first embodiment.

The user manipulates the user terminal 500 to access the report generation device 300, thereby transmitting an incident report generation instruction to the report generation device 300. As the user of the report generation device 300, the operator of the work machine 100 and the operation site manager are exemplary examples.

The input unit of the report generation device 300 responds to the access and receives input of an evaluation target information related to the incident report (Step S1). As the evaluation target information, the operator identification information or the operation site identification information related to the evaluation target, and the evaluation period are exemplary examples. In addition, in a case where the operator identification information is input as the evaluation target, an incident report related to an individual operator is generated, and in a case where the operation site identification information is input, incident reports related to a plurality of the work machines 100 or operators that work at the operation site are generated.

When the user manipulates the user terminal 500 to input the evaluation target information to the report generation device 300, the calculation unit 313 reads the history data related to the input evaluation target from the storage 350 (Step S2). For example, the calculation unit 313 reads, from among the history data stored in the storage 350, the operator identification information or the operation site identification information related to the evaluation target, and the information associated with the evaluation period. The calculation unit 313 calculates the score of each incident risk at each time related to the evaluation period on the basis of the warning history data among the read history data (Step S3). That is, the calculation unit 313 calculates the fall-risk-related score on the basis of the flowchart shown in FIG. 5, and calculates the collision-risk-related score on the basis of the flowchart shown in FIG. 7.

In addition, in a case where an incident risk does not occur at a certain time and no warning is output, no warning history data related to that time is present. In this case, the calculation unit 313 sets a score related to that time to a minimum value.

Additionally, the calculation unit 313 specifies the number of times of obstacle detection for each direction and the number of times of obstacle detection for each distance around the work machine 100, on the basis of the position of the obstacle when the distance between the work machine 100 and the obstacle calculated in Step S204 is the shortest in each data block of the warning history data (Step S4). The number of times of obstacle detection for each direction is the number of times obstacles are detected at the front, the number of times obstacles are detected at the front right, the number of times obstacles are detected at the rear right, the number of times obstacles are detected at the rear left, and the number of times obstacles are detected at the front left. The number of times of obstacle detection for each distance is the number of times obstacles are detected in the warning region and the number of times obstacles are detected in the control region.

Next, the calculation unit 313 calculates the average score, the maximum score, and the minimum score for each incident risk (Step S5). The generation unit 314 generates the radar chart R2 on the basis of the average score, the maximum score, and the minimum score that are calculated in Step S5 (Step S6).

Next, the generation unit 314 generates the time chart R3 representing changes over time in the score of each incident risk on the basis of the score calculated in Step S3 (Step S7).

Next, the calculation unit 313 calculates an area in which the work machine 100 has stayed for each time on the basis of the position history data during operation read in Step S2 (Step S8). Next, the calculation unit 313 calculates the stay time in each area by integrating the stay time in each area (Step S9). The calculation unit 313 associates the score calculated in Step S3 with the area on the basis of the stay time in each area, and calculates the average score of each area (Step S10). The calculation unit 313 specifies the maximum score of each incident risk among the scores calculated in Step S3, and specifies a position related to the score (Step S11). For example, the calculation unit 313 specifies the time related to the maximum score, and specifies the position associated with the stay time specified in Step S8 as the position related to the maximum score.

The generation unit 314 generates the operation area map R4 by dividing the map representing the operation site stored in the storage 350 into a plurality of areas by grids, disposing an object having a size according to the stay time calculated in Step S9 and a color according to the average score calculated in Step S10 in a grid related to each area, and further disposing a pin at the position specified in Step S11 (Step S12).

On the basis of the score calculated in Step S3, the calculation unit 313 specifies the time at which the fall-risk-related warning is issued (Step S13). The calculation unit 313 specifies the posture of the work machine 100 at the time at which the warning is issued, using the warning history data related to the specified time among the warning history data read out in Step S2 (Step S14). That is, the calculation unit 313 specifies the inclination angle and swing angle of the work machine 100 and the angle of the work equipment 150 at the time at which the warning is issued. The generation unit 314 specifies the direction in which the work machine 100 is most inclined among the front, rear, left, and right sides of the work machine 100 on the basis of the specified posture at each time specified in Step S13 (Step S15). Specifically, the calculation unit 313 obtains inclination angles in a front-rear direction and a left-right direction on the basis of the warning history data of the posture, and specifies the inclination direction on the basis of an inclination angle having a larger absolute value, out of the inclination angle in the front-rear direction and the inclination angle in the left-right direction.

The generation unit 314 generates the inclination frequency image R5 by generating the front detection image, the rear detection image, the left detection image, and the right detection image on the basis of the direction specified in Step S15 and disposing each detection image around the machine image (Step S16). Additionally, the generation unit 314 specifies a posture related to the highest score among the postures specified in Step S14, and reproduces the posture in a three-dimensional model of the work machine 100 (Step S17). That is, the generation unit 314 determines the angle of each part of the three-dimensional model of the work machine 100 on the basis of the posture related to the highest score. The generation unit 314 generates the inclination posture image R6 by disposing the line of sight in the direction specified in Step S15 and rendering the three-dimensional model (Step S18).

The generation unit 314 normalizes the number of times of obstacle detection for each direction calculated in Step S4 to a value in the range of 0 or more and 1 or less (Step S19). Next, the generation unit 314 converts the normalized number of times of detection into hue (Step S20). The generation unit 314 generates a direction-specific obstacle detection frequency image R7 by generating the front detection image, the front right detection image, the rear right detection image, the rear left detection image, and the front left detection image on the basis of the specified hue and disposing each detection image around the machine image (Step S21). In addition, by normalizing the number of times of obstacle detection, it is possible to easily recognize a difference in hue, that is, a difference in the number of times of detection, even in a case where the number of times of obstacle detection is generally small or large.

The generation unit 314 generates the distance-specific obstacle detection frequency image R8 by generating the warning region detection image and the control region detection image on the basis of the number of times of obstacle detection for each distance calculated in Step S4 and disposing each detection image around the machine image (Step S22).

The generation unit 314 generates the incident report R, using the evaluation target information R1 received in Step S1, the radar chart R2 generated in Step S5, the time chart R3 generated in Step S6, the operation area map R4 generated in Step S11, the inclination frequency image R5 generated in Step S15, the inclination posture image R6 generated in Step S17, the direction-specific obstacle detection image R7 generated in Step S23, and the distance-specific obstacle detection image R8 generated in Step S24 (Step S23). The output unit 315 outputs the incident report data related to the generated incident report R to the user terminal 500 that has received access in Step S1 (Step S24).

The user of the user terminal 500 can visually recognize the incident report R 10 and recognize the incident risk by displaying or printing the incident report data received by the user terminal 500. Additionally, the user can distribute the displayed or printed incident report R to the operator to make the operator recognize the incident risk.

<<Actions and Effects>>

In this way, according to the first embodiment, the report generation device 300 calculates a score on the basis of the risk time from the occurrence time of the incident risk to the elimination time of the incident risk, and outputs the radar chart R2 representing the score. Accordingly, since the report generation device 300 calculates a score depending on the length of time that a state in which a risk is present continues, the safety of the work machine 100 can be appropriately evaluated.

In particular, according to the first embodiment, the report generation device 300 calculates the collision-risk-related score on the basis of the total sum of the risk time from the time when the entering of an obstacle into a region is detected to the time when the obstacle is no longer detected in the region. Accordingly, in a case where an obstacle is detected in the warning region for a long time, the report generation device 300 can lower the score compared to a case where obstacles are detected multiple times in a short time in the vicinity of the warning region.

Additionally, according to the first embodiment, the report generation device 300 calculates the fall-risk-related score on the basis of the total sum of the risk time from the time when the fall risk is detected to the time when the fall risk is no longer detected. Accordingly, the report generation device 300 can increase the score compared to a case where the work machine 100 has actually fallen in a case where postures that are simply likely to fall are detected multiple times.

### Other Embodiments

Although one embodiment has been described in detail with reference to the drawings, the specific configuration is not limited to the above-described one, and various design changes and the like can be made. That is, in other embodiments, the order of the processing described above may be appropriately changed. Additionally, some processing may be executed in parallel.

The report generation device 300 according to the above-described embodiment may be configured by a single computer, or may be one functioning as the report generation device 300 as the configuration of the report generation device 300 is divided and disposed in a plurality of computers and the plurality of computers cooperate with each other. In this case, some of the computers constituting the report generation device 300 may be mounted inside the work machine 100, and the other computers may be provided outside the work machine 100.

For example, in the first embodiment, the report generation device 300 specifies the magnitude of the incident risk on the basis of the warning history data transmitted from the work machine 100, but in other embodiments, the present invention is not limited to this. For example, in another embodiment, the control device 190 of the work machine 100 may calculate a score from the warning history data to generate the history data of the score, and may transmit the history data of the score to the report generation device 300. That is, some or all of the processing shown in FIGS. 5 and 7 may be performed by the control device 190 of the work machine 100. In this case, the control device 190 may measure the risk time in real time with a timer. In addition, in a case where the risk time is measured in real time, the control device 190 may not calculate the risk time after the control device 190 determines that the fall-related risk time exceeds the threshold. In the above-described embodiment, the fall-related risk time is used to determine whether or not the threshold is exceeded. Therefore, it is not always necessary to calculate the time until return.

In the first embodiment, the direction-specific obstacle detection image R7 and the distance-specific obstacle detection image R8 represent the number of times of obstacle detection, but the present invention is not limited to this. For example, the direction-specific obstacle detection image R7 and the distance-specific obstacle detection image R8 according to another embodiment may represent the total sum of risk times. That is, in another embodiment, the magnitude of the incident risk may be represented by the direction-specific obstacle detection image R7 and the distance-specific obstacle detection image R8 instead of the radar chart R2.

In the first embodiment, the direction-specific obstacle detection image R7 represents the number of times of obstacle detection by hue, but the present invention is not limited to this. For example, the direction-specific obstacle detection image R7 according to another embodiment may represent the number of times of obstacle detection by brightness. Additionally, the number of images representing the directions of the direction-specific obstacle detection images is not limited to five.

In the first embodiment, the distance-specific obstacle detection image R8 represents the number of times of obstacle detection by a numerical value, but the present invention is not limited to this. For example, the distance-specific obstacle detection image R8 according to another embodiment may represent the number of times of obstacle detection by brightness or hue.

Additionally, in the first embodiment, when the collision-risk-related score is calculated, the report generation device 300 measures the risk time from the time when the entering of at least one obstacle into the region is detected to the time when all obstacles are no longer detected in the region, but the present invention is not limited to this. For example, in another embodiment, the report generation device 300 separates and specifies one or more obstacles from the captured image and the measured values of the radar devices 109, and may measure the risk time from the time of entry of each obstacle into a region to the time of exit of the obstacle from the region. For example, the report generation device 300 may calculate the collision-risk-related score by substituting the total sum of the control duration and the warning duration calculated using the risk time of each obstacle into the Formula (2).

Additionally, in another embodiment, the report generation device 300 calculates each of the fall-risk-related score and the collision-risk-related score on the basis of the risk time, but the present invention is not limited to this. For example, in other embodiments, either the fall-risk-related score or the collision-risk-related score may be calculated without being based on the risk time.

### Industrial Applicability

According to the aspect described above, the safety evaluation system can appropriately evaluate the safety of the work machine.

### Reference Signs List

1: Risk management system
100: Work machine
101: Position and azimuth direction detector
102: Inclination detector
103: Traveling acceleration sensor
104: Swing angle sensor
105: Boom angle sensor
106: Arm angle sensor
107: Bucket angle sensor
108 Imaging device
109: Radar device
110: Undercarriage
130: Swing body
150: Work equipment
151: Boom
152: Arm
153: Bucket
170: Cab
190: Control device
210: Processor
211: Acquisition unit
212: Determination unit
213: Transmission unit
230: Main memory
250: Storage
270: Interface
300: Report generation device
310: Processor
311: Reception unit
312: Input unit
313: Calculation unit
314: Generation unit
315: Output unit
330: Main memory
350: Storage
370: Interface
500: User terminal

1. A safety evaluation system comprising:
a risk detection unit that detects an occurrence risk of an incident related to a work machine;
a time calculation unit that measures a risk time from an occurrence time of the risk to an elimination time of the risk;
an evaluation unit that calculates a safety evaluation index on the basis of the risk time; and
an output unit that outputs the safety evaluation index.

2. The safety evaluation system according to claim 1,
wherein the risk detection unit detects a risk that an obstacle is present within a predetermined region centered on the work machine,
the time calculation unit measures the risk time from a time when entering of an obstacle into the region is detected to a time when the obstacle is no longer detected in the region, and
the evaluation unit calculates the safety evaluation index on the basis of a total sum of the risk time.

3. The safety evaluation system according to claim 2,
wherein the region has a first region centered on the work machine and a second region outside the first region, and
the time calculation unit measures each of a risk time related to the first region and a risk time related to the second region.

4. The safety evaluation system according to claim 3,
wherein the evaluation unit calculates the safety evaluation index on the basis of the risk time related to the first region and the risk time related to the second region.

5. The safety evaluation system according to claim 4,
wherein the evaluation unit calculates the safety evaluation index on the basis of a sum of a value obtained by multiplying the risk time related to the first region by a first coefficient and a value obtained by multiplying the risk time related to the second region by a second coefficient smaller than the first coefficient.

6. The safety evaluation system according to claim 2,
wherein the time calculation unit measures the risk time from a time when entering of at least one obstacle into the region is detected to a time when all obstacles are no longer detected in the region.

7. The safety evaluation system according to claim 1,
wherein the risk detection unit detects a fall risk on the basis of a posture of the work machine, and
the evaluation unit deducts points from the safety evaluation index in a case where the risk time exceeds a predetermined threshold.

8. The safety evaluation system according to claim 7,
wherein the evaluation unit calculates the safety evaluation index on the basis of a sum of a value obtained by multiplying the number of times the risk time exceeds a predetermined threshold by a third coefficient and a value obtained by multiplying the number of times of occurrence of the risk by a fourth coefficient smaller than the third coefficient.

9. The safety evaluation system according to claim 8,
wherein the risk detection unit detects a first risk and a second risk with a higher possibility of falling than the first risk, on the basis of the posture of the work machine, and
the time calculation unit measures a risk time related to the second risk.

10. The safety evaluation system according to claim 9,
wherein the evaluation unit calculates the safety evaluation index on the basis of the number of times the risk time of the second risk exceeds the predetermined threshold and the number of times of occurrence of the first risk.

11. The safety evaluation system according to claim 10,
wherein the evaluation unit calculates the safety evaluation index on the basis of a sum of a value obtained by multiplying the number of times the risk time of the second risk exceeds the predetermined threshold by the third coefficient and a value obtained by multiplying the number

12. A safety evaluation method comprising:
a step of detecting an occurrence risk of an incident related to a work machine using a safety evaluation system;
a step of measuring a risk time from an occurrence time of the risk to an elimination time of the risk using the safety evaluation system;
a step of calculating a safety evaluation index on the basis of the risk time using the safety evaluation system; and
a step of outputting the safety evaluation index using the safety evaluation system.
